(19) United States
(12) Patent Application Publication
(10) Pub. No.: US 2004/0252597 A1
(43) Pub. Date: Dec. 16, 2004

(54) Optical head and an optical information recording medium driving device

(76) Inventors: Hideki Nakata, Seika-cho (JP); Hironori Tomita, Ikoma-shi (JP); Takeshi Ohta, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/864,327

(22) Filed: Jun. 10, 2004

(30) Foreign Application Priority Data
Jun. 13, 2003 (JP) 2003-169063(PAT.)

(51) Int. Cl. G11B 7/00

(52) U.S. Cl. 369/44.14; 369/112.01

(57) ABSTRACT

An optical head is provided with a semiconductor laser, an objective lens for gathering a beam from the semiconductor laser on an optical information recording medium, an objective lens actuator for driving the objective lens along a focusing direction and a tracking direction of the optical information recording medium, a metal-made optical base for holding the semiconductor laser and the objective lens actuator, and a feed screw and a guide shaft for guiding the optical base along the radial direction of the optical information recording medium. The optical base and the feed screw or the guide shaft are held in contact with sliding members made of a resin or a ceramic and having a heat conductivity. Thus, even if burrs are formed at slide holes during the molding of the optical base, a good slidability can be ensured for the feed screw and the guide shaft, and heat produced by the semiconductor laser can be radiated via the sliding members.

### BACKGROUND OF THE INVENTION

i) Field of the Invention

The present invention relates to an optical head used in an optical information recording medium driving device for optically recording and reproducing information by projecting a light spot to a disk-shaped information recording medium.

ii) Related Art

In recent years, optical heads and disk recording/reproducing apparatuses have become more diverse such as DVDs, MDs. CDs. CD-Rs, and have come to have higher densities, higher performances, higher qualities and higher added values. Particularly, a demand for portable disk recording/reproducing apparatuses using recordable magneto-optical media is largely on the increase, and such apparatuses are required to be even smaller, thinner and more inexpensive and to have higher performances.

There have been known a large number of technologies on optical heads of disk recording/reproducing apparatuses for magneto-optical disks such as the one disclosed in Japanese Unexamined Patent Publication No. H11-328683. One example of a prior art optical head used in a disk recording/reproducing apparatus for magneto-optical disks is described with reference to the accompanying drawings. FIGS. 9 to 12 are schematic construction diagrams of the prior art optical head and diagrams showing the operation principle thereof.

As shown in FIGS. 9 to 11, an optical head 50 is provided with an integrated unit 9, a reflection mirror 10, an objective lens driving mechanism 14 having an objective lens arranged therein, and an optical base 19.

The integrated unit 9 is, as shown in FIGS. 10 and 11, an integral assembly of a silicon substrate 1, a semiconductor laser 2 as a light source, a multisegment light detector 3, a heat-radiating plate 4, terminals 5, a resin package 6, a resin-made hologram element 7 and a composite element 8. The semiconductor laser 2 is fixed onto the silicon substrate 1. The multisegment light detector 3 is formed on the silicon substrate 1 by a IC process. The heat-radiating plate 4 is for holding the silicon substrate 1 in a heat conductive state. The terminals 5 are connected with output portions 3a of the multisegment light detector 3 by wire bonding 5a or the like. The resin package 6 is for holding the silicon substrate 1, the heat-radiating plate 4 and the terminals 5. The hologram element 7 is formed with a diffraction grating. The composite element 8 includes a beam splitter 8a, a return mirror 8b and a polarization splitter 8c. Identified by 32 in FIG. 10B is a light spot formed on a magneto-optical recording medium 13.

The objective lens driving mechanism 14 is for driving the objective lens 11 along a focusing direction (direction substantially normal to the magneto-optical recording medium 13) and a radial direction (directions substantially in parallel with the magneto-optical recording medium 13) of the magneto-optical recording medium 13. The magneto-optical recording medium 13 is an information recording medium having a magneto-optical effect.

As shown in FIG. 9, the objective lens driving mechanism 14 includes the objective lens 11, an objective lens holder 12, a base 15, a suspension 16, a magnetic circuit 17, and coils 18a, 18b. The objective lens 11 is fixed to the objective lens holder 12 and forms a light spot 32 (see FIG. 10B) on the magneto-optical recording medium 13 using a beam from the semiconductor laser 2. The objective lens 11 can be driven along the focusing direction by applying a power to the coil 18a, whereas it can be driven along the radial direction by applying a power to the coil 18b.

The reflection mirror 10 and the integrated unit 9 are held by the optical base 19. This optical base 19 includes fixing portions 19a for the reflection mirror 10 and fixing portions 19b for the integrated unit 9. The integrated unit 9 is fixed by adhering the resin package 6 to the fixing portions 19b of the optical base 19. On the optical base 19, a focusing error signal receiving area 24 of the multisegment light detector 3 is located substantially between focal points 30, 31 of a light spot for detecting a focusing error signal along Z-axis direction (optical axis direction). Heat generated by the semiconductor laser 2 is transferred to the optical base 19 via the heat-radiating plate 4 and the resin package 6, and radiated to the air via this optical base 19. The efficient radiation of the heat generated by the semiconductor laser 2 to the air by means of the optical base 19 and the like prevents the temperature of the semiconductor laser 2 itself from largely increasing to suddenly increase a consumed current and also prevents the deterioration of the semiconductor laser 2. As a result, the reliability of the optical head 50 can be remarkably improved. Identified by 35 in FIG. 9 in a flexible circuit.

As shown in FIG. 11, the multisegment light detector 3 is provided with the focusing error signal receiving area 24, tracking error signal receiving areas 25, 26 and an information signal receiving area 27. A light spot 20 for detecting the focusing error signal is projected onto the focusing error signal receiving area 24; a light spot 21 for detecting a tracking error signal onto the tracking error signal receiving areas 25, 26; and a main beam (P-polarized light) 22 and a main beam (S-polarized light) 23 on the information signal receiving area 27. Identified by 46, 28 and 29 in FIG. 11 are an edged mirror, a subtracter and an adder, respectively.

As shown in FIG. 12, the optical head 50 is moved in the radial direction of the magneto-optical recording medium 13 by an optical head feeding mechanism 47. This optical head feeding mechanism 47 is comprised of a feed screw 36, an auxiliary shaft 37, a feed motor 38, gears 39a, 39b, a nut plate 40 formed on a cover 33, bearings 41, and the like, and mounted on a mechanism base 42. The optical head 50 is moved in the radial direction of the magneto-optical recording medium 13 as the feed screw 36 slides relative to slide holes 19c (see FIG. 9) of the optical base 19 and the auxiliary shaft 37 slides relative to a slide hole 19e (see FIG. 9) of the optical base 19. At this time, the nut plate 40 is engaged with the feed screw 36 and, when the feed screw 36 is rotated, the entire optical head 50 is moved in the radial direction by an amount determined by a gear ratio of the gears 39a and 39b and a deceleration rate calculated based on the pitches of the feed screw 36.

The operation of the prior art optical head 50 constructed as above is described.

As shown in FIGS. 10A and 10B, a light emitted from the semiconductor laser 2 is split into a plurality of beams by the hologram element 7. After transmitting the beam splitter 8a of the composite element 8 and being reflected by the reflection mirror 10, some of the beams transmit the objective lens 11, thereby being gathered as a light spot 32 having a diameter of about 1 micron onto the magneto-optical recording medium 13. On the other hand, the beams reflected by the beam splitter 8a of the composite element 8 are incident on a light receiving element (not shown) for laser monitoring to control a drive current of the semiconductor laser 2.

The reflected light from the magneto-optical recording medium 13 follows a reverse path, thereby being incident on the polarization splitter 8c after being reflected and split by the beam splitter 8a of the composite element 8 and being reflected by the return mirror 8b.

The semiconductor laser 2 is so placed on the silicon substrate 1 as to have a polarizing direction in parallel with the plane of FIG. 10A. The incident light on the polarization splitter 8c is incident on the information signal receiving area 27 (see FIG. 11) after being split into two beams of polarization components normal to each other.

Out of the reflected light from the magneto-optical recording medium 13, the beam having transmitted through the beam splitter 8a is split by the hologram element 7 into a plurality of beams, which are gathered onto the focusing error signal receiving area 24 and the tracking error signal receiving areas 25, 26. It should be noted that focusing servo is performed by a so-called SSD method and tracking servo is performed by a so-called push-pull method.

A magneto-optical disk information signal can be detected by a differential detection method for calculating differences between the magneto-optical disk information signal and the main beam 22 formed by the P-polarized light, the main beam 23 formed by the S-polarized light. A pre-pit signal can be detected by taking a sum of these differences.

At the time of reproducing and recording the information in the magneto-optical recording medium 13, the objective lens driving mechanism 14 and the optical head feeding mechanism 47 move the objective lens 11 in the radial direction of the magneto-optical recording medium 13.

In the optical head 50 constructed as above, the relative positions of the semiconductor laser 2, the objective lens 11 and the multisegment light detector 3 are adjusted during the assembling in order to obtain a desired detection signal from the reflected light from the magneto-optical recording medium 13. This relative position adjustment is made by specifying the dimensions of the optical base 19 and the resin package 6 of the integrated unit 9. In this position adjustment, an initial position of the focusing error signal is adjusted such that the focusing error signal receiving area 24 of the multisegment light detector 3 will be located substantially between the respective focal points 30, 31 of the light spots along Z-axis direction (optical axis direction). A relative inclination adjustment of the magneto-optical recording medium 13 and the objective lens 11 is made through a skew adjustment of the objective lens 11 and the magneto-optical recording medium 13 while the base 15 is held by an external jig (not shown).

Since the optical base 19 of the optical head 50 having the above construction is die-cast of an aluminum, zinc, magnesium or the like, burrs are formed at the slide holes 19c, 19e during the molding of the optical base 19. Even in the case that the optical base 19 is formed by pressing or forging a plate material for the purpose of producing the optical base 19 less expensive or making it thinner and more rigid, burrs are also formed at the slide holes 19c, 19e during the pressing or forging. These burrs are formed in a direction according to the construction of a mold. Upon the formation of the burrs at the slide holes 19c, 19e, the dimensional precision of the slide holes 19c, 19e is deteriorated. Thus, loads acting during the sliding movements of the feed screw 36 and the auxiliary shaft 37 increase. This leads not only to an increase in the current consumption of the feed motor 38, but also to a maloperation, thereby making an occurrence of a recording error and a reproduction error possible.

Further, the burr may get squeezed between the slide holes 19c and the feed screw 36 during the sliding movement. In such a case, the sliding movement is made difficult to make and gradually gets worse as the feeding operation is repeated.

Furthermore, the removal of the burr by a manual operation or the like is required to increase the production costs. Even if an oil-less metal is used, the production costs become higher.

It can be thought to provide the slide holes 19c, 19e with bearings made of a resin or the like in order to ensure a sufficient slidability. However, if such a construction is adopted, it becomes difficult to radiate the heat produced by the semiconductor laser 2 to the optical base 19 via the feed screw 36 and the auxiliary shaft 37. As a result, the temperature of the semiconductor laser 2 is increased, thereby causing not only a problem of an increased power consumption, but also a problem of a shorter emission life.

### SUMMARY OF THE INVENTION

In view of the problems residing in the prior art, an object of the present invention is to improve a sliding resistance in slide holes of an optical base by reducing the influence of burrs formed on the slide hole, improve a slidability by stabilizing the sliding resistance, and improve the reliability of the optical head by ensuring a sufficient heat radiating property of radiating heat produced by a semiconductor laser.

The present invention takes the following constructions in order to accomplish the above object.

Specifically, an optical head according the present invention comprises a light source; an objective lens for gathering a beam emitted from the light source on an optical information recording medium; an objective lens actuator for driving the objective lens along a focusing direction and a tracking direction of the optical information recording medium; a metal-made optical base for holding the light source and the objective lens actuator; and a metal-made guiding member for guiding the optical base along the radial direction of the optical information recording medium; wherein the optical base and the guiding member are held in contact via a heat conductive sliding member.

Since the sliding member is present between the optical base and the guiding member in this optical head, the slidability of the optical base relative to the guiding member can be remarkably improved. This can lead to a reduction in the power consumption of a feed motor and the like. Since heat produced by the light source can be efficiently transferred to the guiding member via the sliding member and radiated from the guiding member, an increase in the temperature of the light source can be moderated, thereby reducing the power consumption of the light source. As a result, a remarkably extended life of a battery and a longer life of the light source can be expected, and stable recording and reproduction can be realized. Accordingly, the power consumption of the optical head can be reduced and recording and reproducing performances can be improved by causing a sliding property and a heat-radiating property to consist together. Therefore, the reliability of the optical head can be improved.

If the optical base is made of a plate material, e.g. a press-worked product or a forged product of a metal, an optical head having good heat-radiating performance and cost performance can be realized. If the optical base is made of a cast product, an optical base having good heat-radiating performance and dimensional precision can be realized. Thus, an optical head having high performances can be realized. Further, if the optical base is made of a press-worked product, a thin and highly rigid construction can be realized.

The sliding member is preferably made of either a resin or a ceramic. If the sliding member is made of a resin, it can be formed to have a good dimensional precision at a low cost. On the other hand, if the sliding member is made of a ceramic, a degree of abrasion at the time of repeated operations can be remarkably reduced.

If the optical base includes a plate-shaped supporting portion for supporting the guiding member when the optical base is a metal press-worked product, the supporting portion is preferably formed to have a thickness between 0.2 mm (inclusive) and 1.2 mm (inclusive). A necessary strength can be ensured if the thickness of the supporting portion is 0.2 mm or larger, whereas the optical base can be precisely formed if the thickness of the supporting portion is 1.2 mm or smaller.

The guiding member may be formed to a shaft member extending along the radial direction of the optical information recording medium; the optical base may include a supporting portion for supporting the guiding member; the supporting portion may be formed with one of a through hole and a groove; and the sliding member may be formed to have either an annular shape or a C-shape and mounted in the through hole or the groove of the supporting portion, and have the guiding member inserted thereinto.

If the heat conductivity of the sliding member is between 5 W/m·k (inclusive) and 50 W/m·k (inclusive), an optical head having good sliding performance, heat-radiating property and cost performance can be realized

If the heat conductivity of the sliding member is between 10 W/m·k (inclusive) and 40 W/m·k (inclusive), the deterioration of the moldability of the sliding member can be suppressed while a variation in the temperature of the light source depending on a variation in heat conductivity can be suppressed. Thus, a cost increase can be suppressed.

If the sliding member is made of a resin and electrically conductive, the optical base and the guiding member can be held at the same potential even if the resin-made sliding member is used. Thus, electrostatics on the optical base can be discharged toward the guiding member while the heat-radiating property is maintained. Therefore, an optical head unlikely to be influenced by noise can be realized, thereby improving the reliability of the optical head.

In this case, the sliding member is preferably made of such a resin in which 20% (inclusive) to 80% (inclusive) by mass of either one of a metal and a carbon is contained in a resin material as a base material, and the metal is preferably any one of a copper-containing metal, an iron-containing metal and an aluminum-containing metal. If the content of the metal or the carbon is between 20% (inclusive) and 80% (inclusive), the moldability of the sliding member can be maintained while the heat-radiating property of the optical base is maintained.

On the other hand, if the sliding member is made of a resin and electrically insulating, the optical base and the guiding member can be electrically shut off from each other if the resin-made sliding member is used. Thus, an optical head capable of performing stable recording and reproduction even if there is a difference between the potential of the optical base and that of the guiding member while maintaining the heat-radiating property can be realized.

In this case, the sliding member is preferably made of such a resin in which 20% (inclusive) to 80% (inclusive) by mass of an electrically nonconductive hard material is contained in a resin material as a base material, and the electrically nonconductive material is preferably any one of a ceramic, a ruby and a diamond. If the content of the electrically nonconductive hard material is between 20% (inclusive) and 80% (inclusive), the moldability of the sliding member can be maintained while the heat-radiating property of the optical base is maintained.

If the optical base and the sliding member are integrally formed by molding, an optical head having good cost performance, dimensional precision and assembling operability can be realized.

The present invention is also directed to an optical information recording medium driving device, comprising the above optical head; a tracking control means for calculating a tracking error signal and controlling the position of the objective lens in accordance with the calculated tracking error signal to cause a gathered light spot to follow a specified information track on the optical information recording medium; and a focusing control means for calculating a focusing error signal and controlling the position of the objective lens in accordance with the calculated focusing error signal to cause the gathered light spot on the optical information recording medium; wherein the optical base and the guiding member are held in contact via a heat conductive sliding member.

As described above, according to the present invention, sliding movements of the metal-made optical base are stabilized by making the sliding member of a resin or a ceramic, and the sliding member is formed to be heat conductive. Thus, heat produced by the light source can be efficiently radiated via the guiding member, thereby enabling a lower power consumption of the light source, the feed motor and the like, the high reliability of the feeding operation, the high reliability and longer life of the light source. Therefore, an optical head and an optical information recording medium driving device having a low power consumption and a high reliability can be realized. If the optical base is made of a metal plate material, the optical head and the optical information recording medium driving device can be made even thinner and produced at lower costs.

### BRIEF DESCRIPTION OF THE DRAWINGS

FIG. 1 is an exploded perspective view showing parts of an optical head according to a first embodiment of the present invention,

FIG. 2A is a diagram schematically showing an optical path in the optical head, and FIG. 2B is a diagram showing the optical path in a direction normal to the plane of FIG. 2A,

FIG. 3 is a plan view showing a multisegment light detector of the optical head,

FIG. 4 is a perspective view showing the optical head and an optical head feeding mechanism,

FIG. 5 is a section showing a first supporting portion provided in an optical base of the optical head, a sliding member fitted in slide holes of the first supporting potion, and a feed screw,

FIGS. 6A and 6B are diagrams showing a method for adjusting the optical head,

FIG. 7 is a schematic diagram showing an optical disk driving device to which the optical head is applied,

FIG. 8 is a graph showing a simulation result of a relationship between the heat conductivity of a sliding member provided and a temperature increase of a semiconductor laser according to a second embodiment,

FIG. 9 is an exploded perspective view showing parts of a prior art optical head,

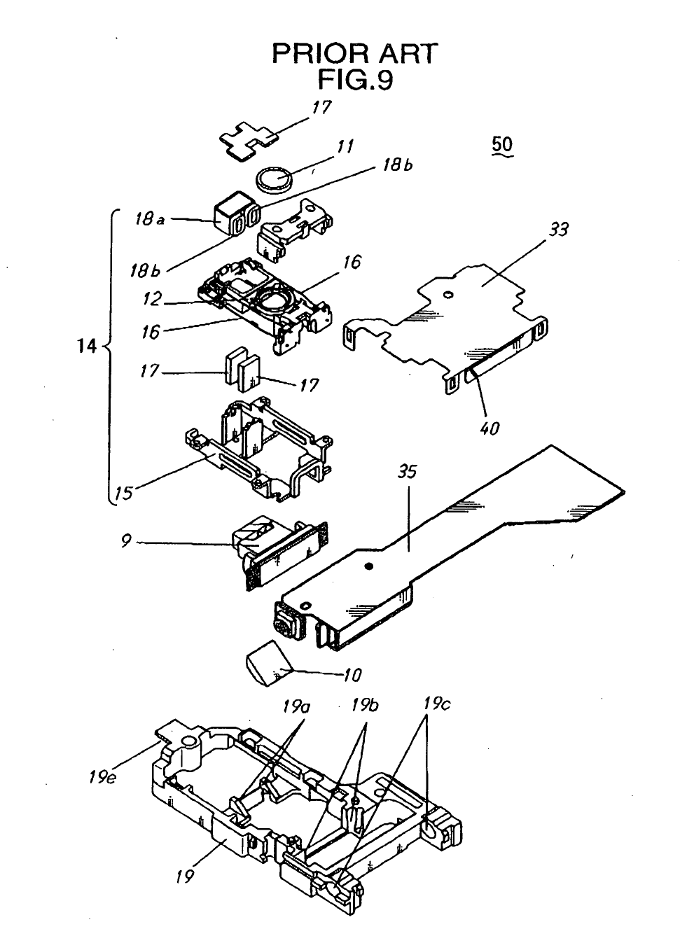

FIG. 10A is a diagram schematically showing an optical path in a prior art optical head, and FIG. 10B is a diagram showing the optical path in a direction normal to the plane of FIG. 10A,

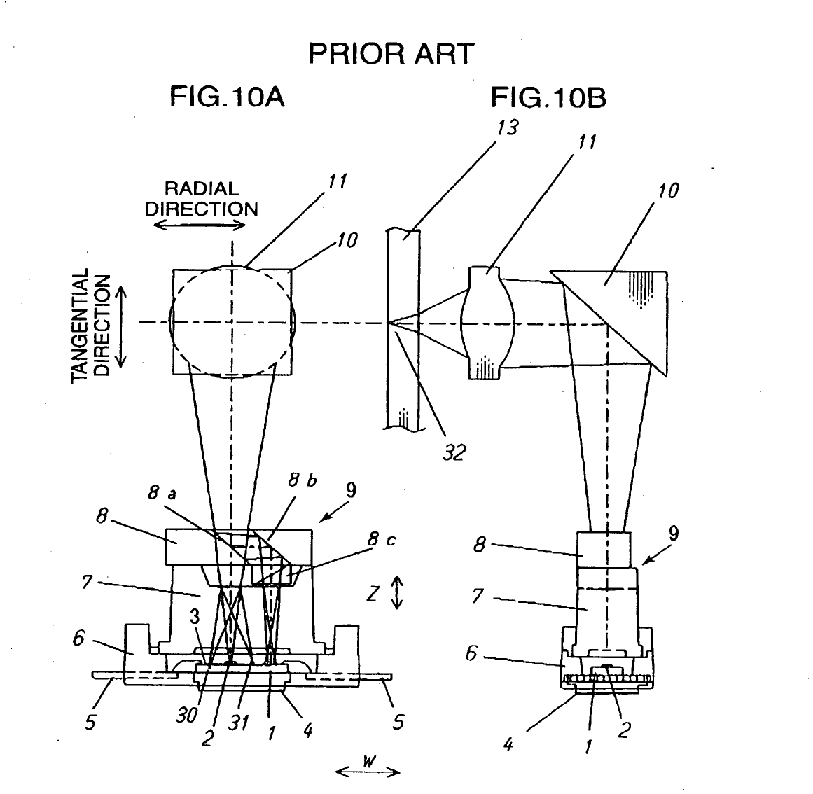

FIG. 11 is a plan view showing a multisegment light detector of the prior art optical head, and

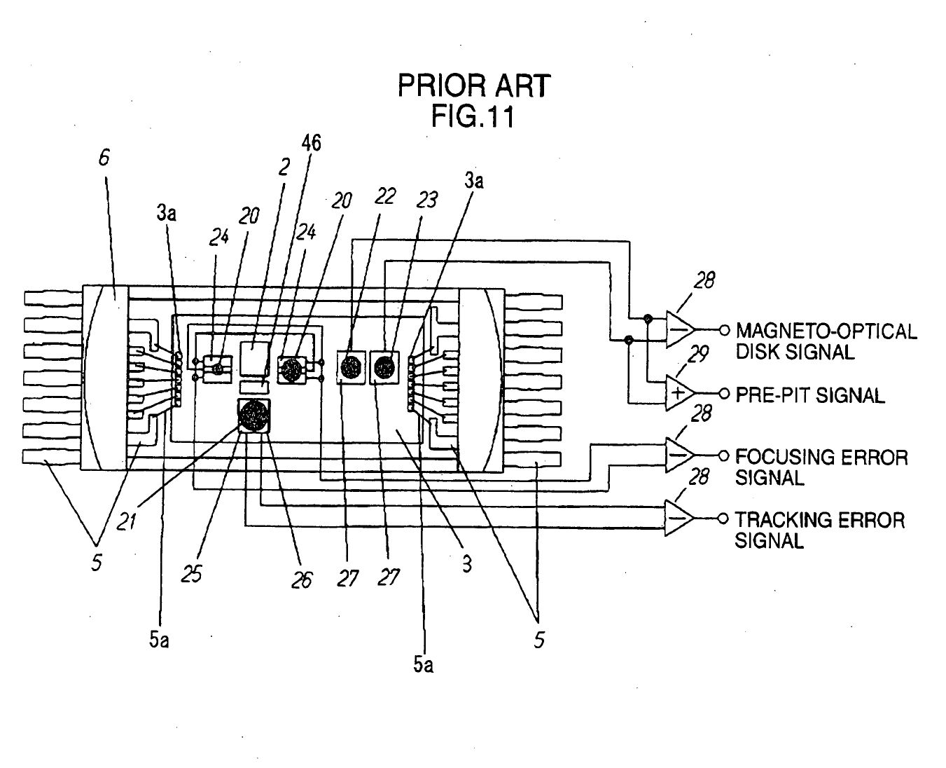

FIG. 12 is a perspective view showing the prior art optical head and a prior art optical head feeding mechanism.

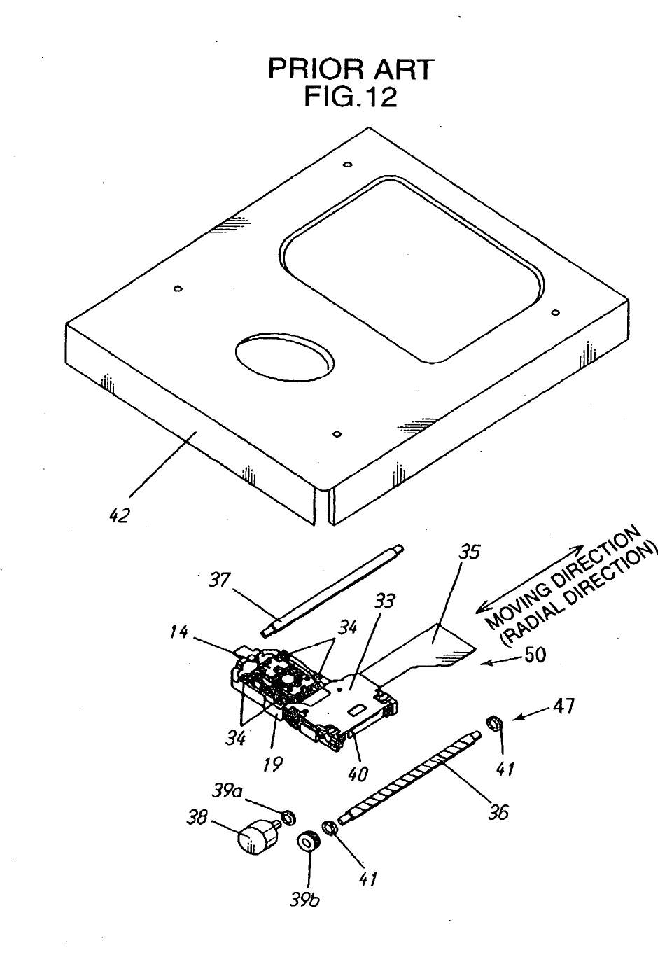

### BEST MODES FOR EMBODYING THE INVENTION

Hereinafter, embodiments of the present invention are described in detail with reference to the accompanying drawings. It should be noted that the present invention is not limited to the following embodiments.

(First Embodiment)

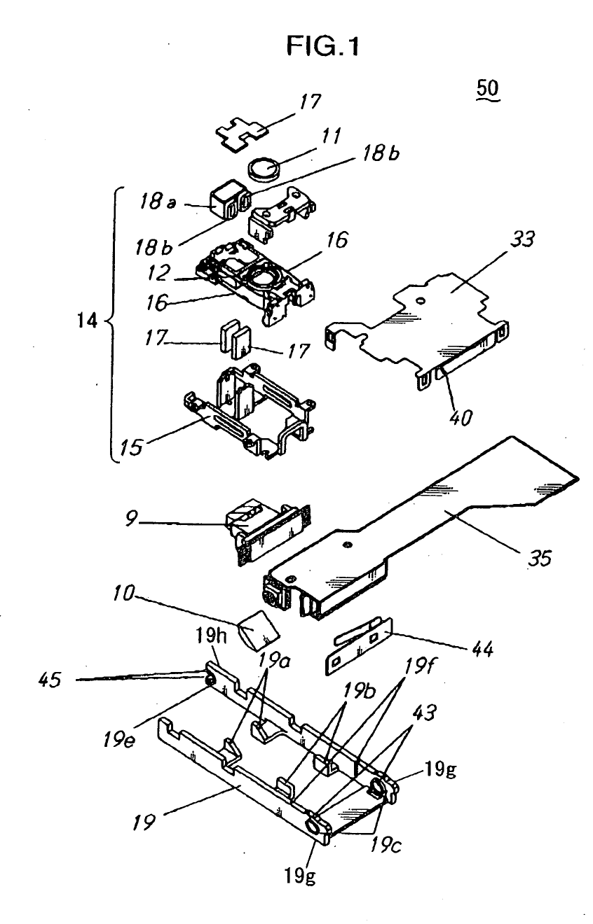

As shown in FIG. 1, an optical head 50 according to a first embodiment of the present invention is provided with an integrated unit 9, a reflection mirror 10, an objective lens driving mechanism 14 having an objective lens 11 arranged therein, and an optical base 19.

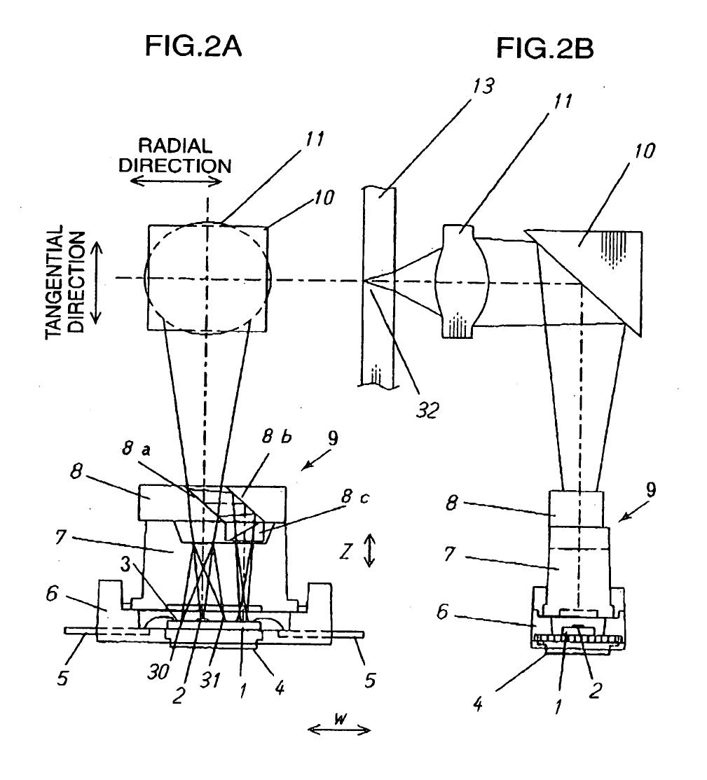

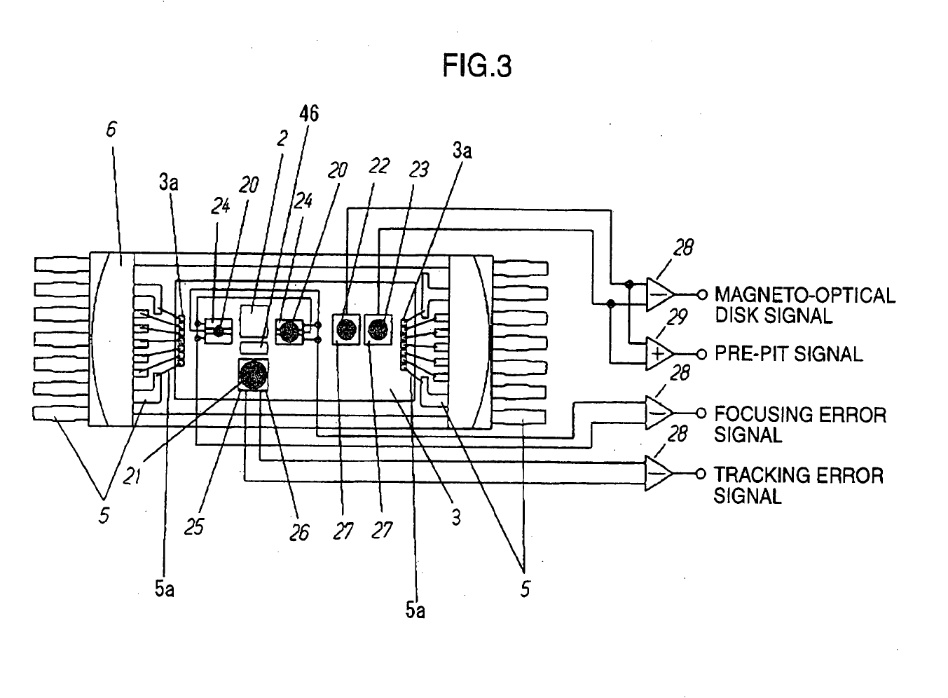

The integrated unit 9 is, as shown in FIGS. 2 and 3, an integral assembly of a silicon substrate 1, a semiconductor laser 2 as a light source, a multisegment light detector 3, a heat-radiating plate 4, terminals 5, a resin package 6, a hologram element 7 made of a resin, and a composite element 8. The semiconductor laser 2 is fixed to the silicon substrate 1. The multisegment light detector 3 is formed on the silicon substrate 1 by an IC process. The heat-radiating plate 4 holds the silicon plate 1 in a heat conductive state. The terminals 5 are connected with output portions 3a of the multisegment light detector 3 by wire bonding 5a or the like. The resin package 6 holds the silicon substrate 1, the heat-radiating plate 4 and the terminals 5. The hologram element 7 is formed with a diffraction grating. The composite element 8 includes a beam splitter 8a, a return mirror 8b, and a polarization splitter 8c. Identified by 32 in FIG. 2B is a light spot formed on an magneto-optical recording medium 13.

The objective lens driving mechanism 14 drives the objective lens 11 along a focusing direction (direction substantially normal to the magneto-optical recording medium 13) and a radial direction (direction substantially in parallel with the magneto-optical recording medium 13) of the magneto-optical recording medium 13. The magneto-optical recording medium 13 is an information recording medium having an magneto-optical effect and is constructed, for example, as an optical disk.

As shown in FIG. 1, the objective lens driving mechanism 14 includes the objective lens 11, an objective lens holder 12, a base 15, a suspension 16, a magnetic circuit 17, and coils 18a, 18b. The objective lens 11 is fixed to the objective lens holder 12 and forms the light spot 32 on the magneto-optical recording medium 13 using a beam from the semiconductor laser 2. The objective lens 11 can be driven along the focusing direction by applying a power to the coil 18a, whereas it can be driven along the radial direction by applying a power to the coil 1b. Identified by 35 in FIG. 1 is a flexible circuit.

The reflection mirror 10 and the integrated unit 9 are held by the optical base 19. This optical base 19 includes fixing portions 19a for the reflection mirror 10 and fixing portions 19b for the integrated unit 9. The integrated unit 9 is fixed by adhering the resin package 6 to the fixing portions 19b for the optical base 19. On the optical base 19, a focusing error signal receiving area 24 of the multisegment light detector 3 is located substantially between focal points 30, 31 of a light spot for detecting a focusing error signal along Z-axis direction (optical axis direction) (see FIG. 2A).

Heat generated by the semiconductor laser 2 is transferred to the optical base 19 via the heat-radiating plate 4 and the resin package 6, and radiated to the air via this optical base 19. The efficient radiation of the heat generated by the semiconductor laser 2 to the air by means of the optical base 19 and the like can prevent the temperature of the semiconductor laser 2 itself from largely increasing to suddenly increase a consumed current and can also prevent the deterioration of the semiconductor laser 2. As a result, the reliability of the optical head 50 can be remarkably improved.

As shown in FIG. 3, the multisegment light detector 3 is provided with the focusing error signal receiving area 24, tracking error signal receiving areas 25, 26 and an information signal receiving area 27. A light spot 20 for detecting the focusing error signal is projected onto the focusing error signal receiving area 24; a light spot 21 for detecting a tracking error signal onto the tracking error signal receiving areas 25, 26; and a main beam (P-polarized light) 22 and a main beam (S-polarized light) 23 on the information signal receiving area 27. Identified by 46, 28 and 29 in FIG. 3 are an edged mirror, a subtracter and an adder, respectively.

As shown in FIG. 1, the optical base 19 is provided with fixing portions 19f for a heat-radiating plate 44. When the heat-radiating plate 44 is fixed by these fixing portions 19f, a part of the heat-radiating plate 44 and the heat-radiating plate 4 of the integrated unit 9 fixed to the optical base 19 are brought into contact with each other. Accordingly, the heat-radiating plate 4 is held in contact with the optical base 19 via the heat-radiating plate 44. Thus, the heat produced by the semiconductor laser 2 can be transferred to the optical base 19 via the heat-radiating plates 4, 14, and the heat from the semiconductor laser 2 can be radiated to the air by this optical base 19. As a result, the heat produced by the semiconductor laser 2 can be efficiently transferred to the optical bass 19 to be radiated

The optical base 19 is made of a press plate obtained by press-working a plate of a metal material or a forged product of a metal material. These metal materials include a SUS (stainless steel), an aluminum, a SECC (electrogalvanized steel plate), a SPCC (cold rolled steel plate). Since these metal materials have excellent strengths and rigidities, the optical base 19 and the optical head 50 can be thinned if the optical base 19 is formed of a plate member made of such a metal material.

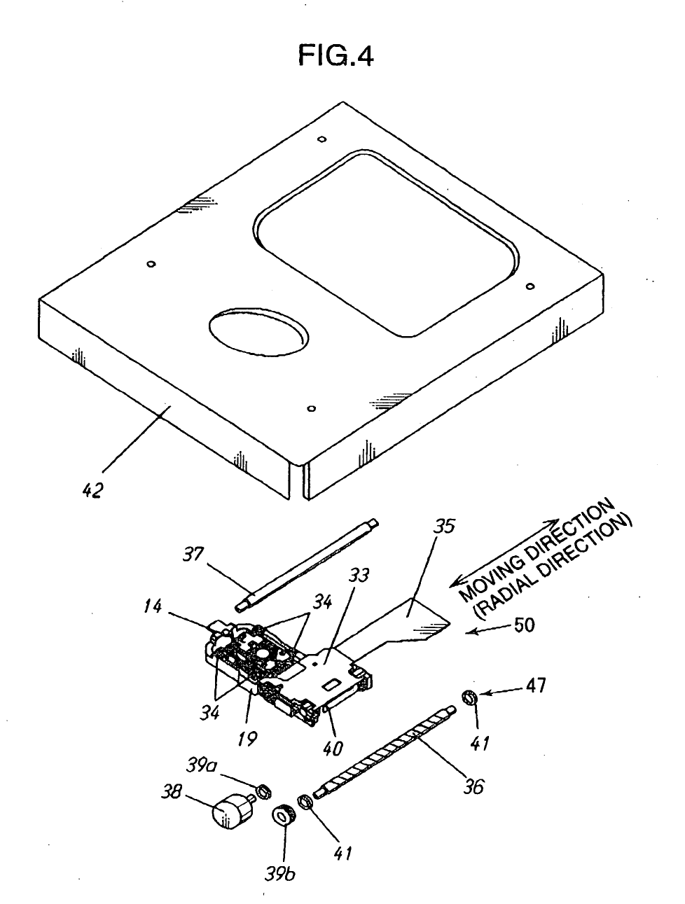

A pair of first supporting portions 19g are provided at one end of the optical base 19, and a slide hole 19c penetrates each first supporting portion 19g. The center axes of the two slide holes 19c are aligned, and each slide hole 19c is integrally formed with a sliding member 43 by molding. These sliding members 43 are formed to have a cylindrical shape, and a feed screw 36 (see FIG. 4) as one example of a shaft member forming a guiding member is inserted through the sliding members 43. In other words, the two first supporting portions 19g are opposite to each other along the extending direction of the feed screw 36, and the feed screw 36 is supported by the first supporting portions 19g.

On the other hand, a second supporting portion 19h is provided at the other end of the optical base 19. An arcuate slide groove 19e is formed in the second supporting portion 19h. The slide groove 19e is integrally formed with a sliding member 45 by molding. This sliding member 45 has a C-shaped cross section, and a guide shaft 37 (see FIG. 4) as one example of the shaft member forming the guide member is inserted through this sliding member 45. This guide shaft 37 is formed by a shaft having a round cross section.

The sliding members 43, 45 are made of a resin containing a hard resin material such as a PPS, a liquid crystal polymer or a Juracon (trade mark) as a base material and additionally containing an aluminum oxide, a metal, a ceramic, a carbon or the like. Accordingly, the sliding members 43, 45 have heat conductivity.

As shown in FIG. 4, the optical head 50 is moved along the radial direction of the magneto-optical recording medium 13 by an optical head feeding mechanism 47. The optical head feeding mechanism 47 includes the feed screw 36, the guide shaft 37, a feed motor 38, gears 39a, 39b, a nut plate 40 provided on a cover 33, bearings 41 and the like. The bearings 41 of the optical head feeding mechanism 47 are mounted on a mechanism base 42, and the opposite ends of the feed screw 36 are fitted into these bearings 41. In other words, the feed screw 36 is supported on the mechanism base 42. A projection (not shown) provided on the nut plate 40 is engaged with the feed screw 36. When the feed screw 36 is turned by the rotation of the feed motor 38, the nut plate 40 engaged with the projection of the feed screw 36 is guided along longitudinal direction by the feed screw 36, whereby the optical head 50 is moved along the radial direction with respect to the mechanism base 42. A fed amount of the optical head 50 is an amount determined by a gear ratio of the gears 39a and 39b and a deceleration rate calculated based on the pitches of the feed screw 36. Identified by 33, 34 in FIG. 4 are the cover and an adhesive.

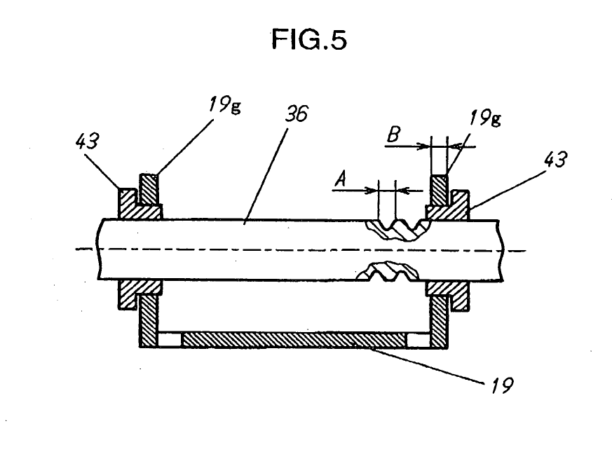

The thickness of the sliding members 43 along the longitudinal direction of the feed screw 36 is larger than a thread interval A of the feed screw 36 as shown in FIG. 5. Thus, the sliding members 43 can be smoothly moved without being influenced by the threads even if being moved along the longitudinal direction of the feed screw 36.

Thickness B of the first supporting portions 19g of the optical base 19 is preferably between 0.2 mm (inclusive) and 1.2 mm (inclusive). A necessary strength cannot be ensured for the optical base 19 if the thickness B of the supporting portions is below 0.2 mm, whereas the supporting portions are difficult to precisely mold in the case of a press plate if it exceeds 1.2 mm. Likewise, thickness of the second supporting portion 19h is preferably between 0.2 mm (inclusive) and 1.2 mm (inclusive).

The operation of the optical head 50 according to the first embodiment is described with reference to FIGS. 1 to 4.

A light emitted from the semiconductor laser 2 is split into a plurality of beams by the hologram element 7. Some of the beams transmit the objective lens 11 to be gathered as a light spot 32 having a diameter of about 1 micron on the magneto-optical recording medium 13 after transmitting the beam splitter 8a of the composite element 8 and being reflected by the reflection mirror 10. On the other hand, the beams reflected by the beam splitter 8a of the composite element 8 are incident on a light receiving element for laser monitoring (not shown) to control a drive current of the semiconductor laser 2.

The reflected light from the magneto-optical recording medium 13 follows a reverse path, thereby being incident on the polarization splitter 8c after being reflected and split by the beam splitter 8a of the composite element 8 and being reflected by the return mirror 8b.

The semiconductor laser 2 is so placed on the silicon substrate 1 as to have a polarizing direction in parallel with the plane of FIG. 2A. The incident light on the polarization splitter 8c is incident on the information signal receiving area 27 (see FIG. 3) after being split into two beams of polarization components normal to each other.

Out of the reflected light from the magneto-optical recording medium 13, the beam having transmitted through the beam splitter 8a is split by the hologram element 7 into a plurality of beams, which are gathered onto the focusing error signal receiving area 24 and the tracking error signal receiving areas 25, 26. It should be noted that focusing servo is performed by a so-called SSD method and tracking servo is performed by a so-called push-pull method.

A magneto-optical disk information signal can be detected by a differential detection method for calculating differences between the magneto-optical disk information signal and the main beam 22 formed by the P-polarized light, the main beam 23 formed by the S-polarized light. A pre-pit signal can be detected by taking a sum of these differences.

In this optical head 50, the relative positions of the semiconductor laser 2, the objective lens 11 and the multisegment light detector 3 are adjusted during the assembling in order to obtain a desired detection signal by the reflected light from the magneto-optical recording medium 13. This relative position adjustment is made by specifying the dimensions of the optical base 19 and the resin package 6 of the integrated unit 9. In this position adjustment, an initial position of the focusing error signal is adjusted such that the focusing error signal receiving area 24 of the multisegment light detector 3 will be located substantially between the respective focal points 30, 31 of the light spots along Z-axis direction (optical axis direction).

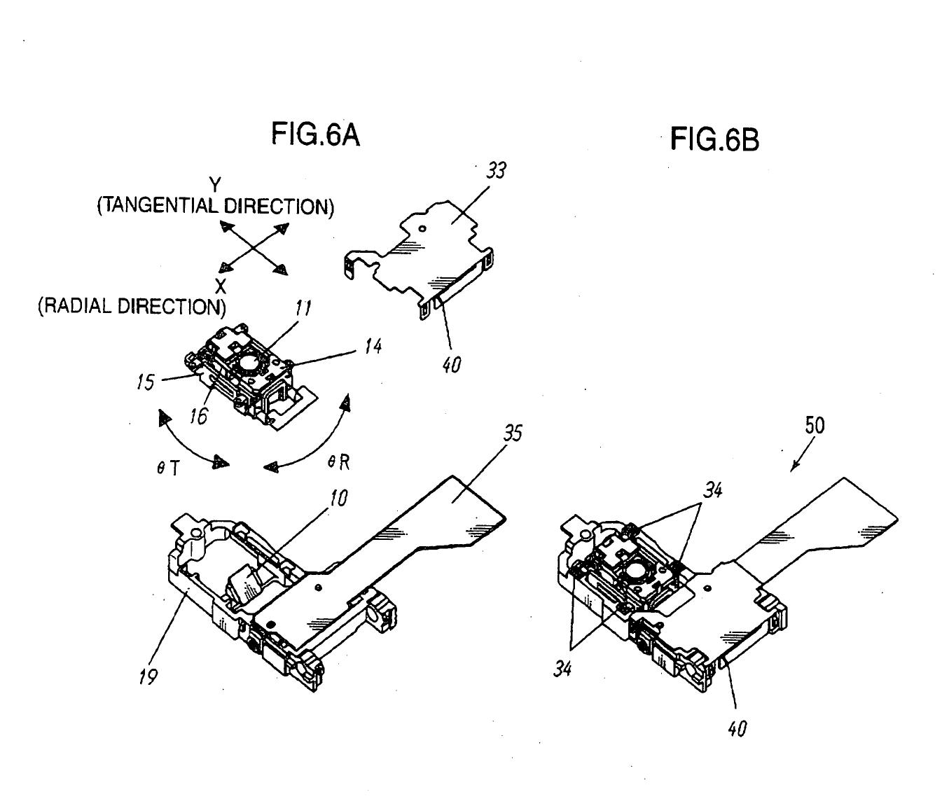

As shown in FIGS. 6A and 6B, the tracking error signal is adjusted by holding the base 15 by means of an external jig (not shown) and moving the objective lens driving mechanism 14 along Y-direction and X-direction to substantially equalize outputs of the tracking error signal receiving areas 25, 26. The adjustment of the tracking error signal results in the alignment of the optical axis of the objective lens 11 with that of the semiconductor laser 2 in FIGS. 6A and 6B.

Further, the relative inclination of the magneto-optical recording medium 13 and the objective lens 11 is adjusted by holding the base 15 by means of the external jig (not shown) and adjusting a skew angle θR along radial direction (about Y-axis) and a skew angle θT along tangential direction (about X-axis) in this state as shown in FIG. 6A. After this relative inclination adjustment, the base 15 is adhered and fixed to the optical base 19 using the adhesive 34 as shown in FIG. 6B. As described above, after the focusing error signal and the tracking error signal are adjusted and the skew adjustment is completed, the objective lens driving mechanism 14 is adhered to the optical base 19 using the adhesive 34, thereby completing the optical head 50.

In this optical head 50, heat produced by the semiconductor laser 2 is transferred to the optical base 19 via the heat-radiating plates 4 and 44 and also via the resin package 6. Then, this heat is radiated from the optical base 19. Further, the heat transferred to the optical base 19 is transferred to the feed screw 36 and the guide shaft 37 via the heat-conductive sliding members 43, 45. Since the sliding members 43, 45 integrally formed with the optical base 19 by molding are precisely aligned with the feed screw 36 and the guide shaft 37 with a view to ensuring a good slidability, the sliding members 43 and the feed screw 36 are kept in contact and the sliding member 45 and the guide shaft 37 are kept in contact. Thus, the heat of the optical base 19 can be efficiently transferred to the feed screw 36 and the guide shaft 37. This heat is transferred to the mechanism base 42 from the feed screw 36 and the guide shaft 37 and radiated therefrom.

Since the sliding members 43, 45 are precisely engaged with the feed screw 36 and the guide shaft 37 and are made of a heat-conductive resin material, the heat produced by the semiconductor laser 2 can be efficiently transferred to the mechanism base 42 from the feed screw 36 and the guide shaft 37 and radiated therefrom. As a result, the sliding property and the heat radiating property of the optical base 19 can consist together and the optical head 50 having high reliability and high performances can be realized.

Further, since the heat produced by the semiconductor laser 2 can be radiated from the feed screw 36 and the guide shaft 37 and radiated from the mechanism base 42 via the feed screw 36 and the guide shaft 37, an increase in consumed current resulting from a temperature increase of the semiconductor laser 2 can be prevented and a reduction in emission life resulting therefrom can be prevented. Therefore, the power consumption of the optical head 50 can be reduced and the reliability thereof can be improved.

Furthermore, since the resin-made sliding members 43, 45 are mounted into the slide holes 19c and the slide groove 19e, a situation where burrs formed during the molding of the optical base 19 get squeezed between the feed screw 36 and the slide holes 19c to make sliding movements impossible can be prevented from occurring, and the gradual deterioration of the slidability by the repeated sliding movements can be avoided. As a result, stable sliding movements can be realized by reducing sliding resistances of the feed screw 36 and the guide shaft 37, and an amount of current consumed by the feed motor 38 can be reduced. Thus, the optical head 50 having a high reliability and a low power consumption can be realized.

Further, since the thin optical base 19 having a high rigidity can be produced at low costs if being formed of a press plate, the optical base 19 and the optical head 50 can be made thinner. Accordingly, the optical head 50 and the optical disk driving device being small and thin and having a high reliability and a lower power consumption can be realized at low production costs.

Although the optical base 19 is formed of a press plate or a forged product in the foregoing embodiment, it may be a cast product of an aluminum, a zinc, a magnesium or the like instead. The resin-made sliding members 43, 45 having a heat conductivity may be mounted into the optical base 19 formed of this cast product.

Further, in the first embodiment, the sliding members 43, 45 may be provided for only one of the feed screw 36 and the guide shaft 37. However, it is preferable to provide the sliding members 43, 45 for both the feed screw 36 and the guide shaft 37 in order to cause the sliding property and the heat-radiating property to consist together.

Although the heat produced by the semiconductor laser 2 is radiated from the heat-radiating plates 4, 44, the optical base 19 and the mechanism base 42, the heat-radiating plate 44 may be omitted and the heat may be radiated from the heat-radiating plate 4, the resin package 6, the optical base 19 and the mechanism base 42.

Instead of the feed screw 36, a shaft member having no external thread may be introduced through the first supporting portions 19g of the optical base 19, and the heat of the sliding member 43 may be transferred to the mechanism base 42 via this shaft member.

Although the sliding members 43, 45 are integrally formed with the optical base 19 by molding in the first embodiment, the present invention is not limited thereto. The sliding members 43, 45 may be formed of a heat-conductive resin or the like separately from the optical base 19, and may be mounted into the slide holes 19c and the slide groove 19e by being pressed thereinto or adhered thereto.

Although the guide shaft 37 is a shaft having a round cross section in the first embodiment, it may be a shaft having a rectangular cross section.

Further, although both the feed screw 36 and the guide shaft 37 transfer heat in the first embodiment, only one of them may transfer heat.

Although the sliding members 43, 45 are made of the heat-conductive resin in the first embodiment, they may be made of a heat-conductive ceramic instead. If the sliding members 43, 45 are ceramic-made, a degree of abrasion resulting from the repeated operations can be remarkably reduced, and the optical head 50 having good heat-radiating property and reliability can be realized.

Here, an optical disk driving device to which the optical head 50 of the first embodiment is applied is described.

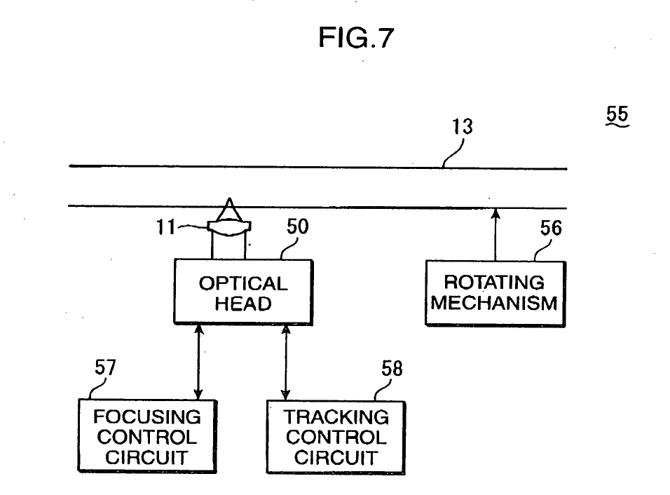

As shown in FIG. 7, an optical disk driving device 55 is provided with a rotating mechanism 56 for rotating the magneto-optical recording medium 13, the optical head 50, a focusing control circuit 57 and a tracking control circuit 58. The focusing control circuit 57 calculates the focusing error signal based on a light receiving signal of the focusing error signal receiving area 24 and controls the position of the objective lens 11 in accordance with this focusing error signal. The tracking control circuit 58 calculates the tracking error signal based on light receiving signals of the tracking error signal receiving area 25, 26 and controls the position of the objective lens 11 in accordance with this tracking error signal. The position of the objective lens 11 is moved along a direction normal to the magneto-optical recording medium 13 and a radial direction of the magneto-optical recording medium 13, whereby the light spot 32 is caused to follow a specified information track on the magneto-optical recording medium 13, thereby recording and reproducing information.

(Second Embodiment)

In the second embodiment, ranges of the heat conductivity of the sliding members 43, 45 are specified. The heat conductivity of the sliding members 43, 45 can be increased by mixing a filler of an aluminum oxide, an alumina, a ceramic, a metal, a carbon or the like into a resin material. The heat conductivity can be increased to enhance the heat-radiating property by setting a high mixing ratio of the filler. However, an excessively high mixing ratio leads to an increased cost and the deterioration of resin properties of the resin members 43, 45 such as rigidity, sliding property and bending elasticity. Therefore, it is necessary to set the heat conductivity in view of the balance of the heat-radiating property, the production costs, and the resin properties.

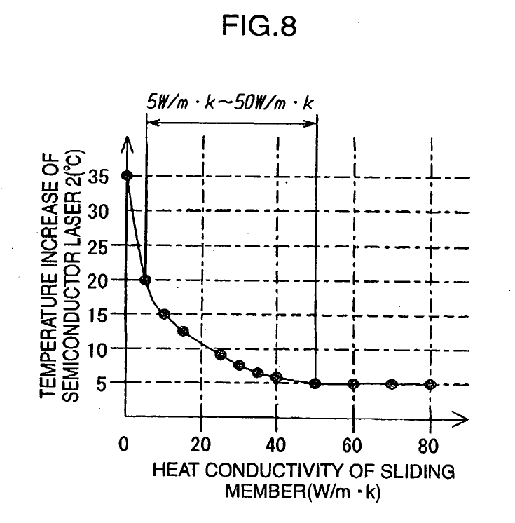

FIG. 8 is a graph showing a simulation result of a correlation of the heat conductivity of the sliding members 43, 45 and the temperature (saturation temperature) of the semiconductor laser 2. It can be understood from FIG. 8 that the higher the heat conductivity of the sliding members 43, 45, the smaller the temperature increase of the semiconductor laser 2. In other words, it can be supposed that heat produced by the semiconductor laser 2 can be efficiently radiated by increasing the heat conductivity of the sliding members 43, 45. It can be thought from FIG. 8 that a sufficient heat-radiating effect can be obtained if the heat conductivity of the sliding members 43, 45 is 5 W/m·k or higher. On the other hand, if the heat conductivity exceeds 50 W/m·k, a difference in the heat conductivity brings about a small influence on the temperature of the semiconductor laser 2 and the mixing ratio of the filler is increased to enter a range where the properties of the resin material are suddenly deteriorated. Thus, such a high heat conductivity is difficult to put into practice. Therefore, the heat conductivity is preferably set within a range of from 5 W/m·k to 50 W/m·k.

The heat conductivity of the sliding members 43, 45 is more preferably set within a range of from 10 W/m·k to 40 W/m·k. Specifically, a variation in the heat-radiating effect caused by a variation in the heat conductivity can be suppressed if the heat conductivity takes a value of 10 W/m·k or larger, whereas the deterioration of the moldability of the sliding members 43, 45 can be suppressed to suppress a cost increase if the heat conductivity takes a value of 40 W/m·k or smaller.

Accordingly, the optical head 50 and the optical disk driving device 55 having good sliding performance, heat-radiating property and cost performance can be realized by specifying the range of the heat conductivity of the sliding members 43, 45.

Although the heat conductivity is increased by mixing the filler made of an aluminum oxide, an alumina, a ceramic, a metal, a carbon or the like into the resin material in the second embodiment, any filler can be used provided that it improves the heat conductivity while maintaining the properties of the resin.

(Third Embodiment)

In the third embodiment, the sliding members 43, 45 possess both heat conductivity and electrical conductivity. Here, electrical conductivity means that volume resistivity is 10² Ω·cm or smaller. The sliding members 43, 45 are made of a resin or a ceramic.

Here, a filler in the case of providing the sliding members 43, 45 with electrical conductivity is preferably a metal such as a copper-containing metal, an iron-containing metal, an aluminum-containing metal or a carbon. Copper-containing metals include coppers and copper alloys. Iron-containing metals include irons. Aluminum-containing metals include an aluminum and aluminum alloys. A mixing ratio of this filler is preferably between 20% (inclusive) and 80% (inclusive) by mass to a base material. If the content of the filler lies within this range, the moldability of the sliding members 43, 45 can be maintained while maintaining the heat-radiating property of the optical base 19.

By taking this construction, the optical base 19, the feed screw 36, the guide shaft 37 and the mechanism base 42 can be held at the same potential. Accordingly, electrostatics produced in the optical base 19 can be discharged to the mechanism base 42. Thus, even in the case of using the sliding members 43, 45 made of a resin or a ceramic, the stable optical disk driving device 55 having a good heat-radiating property and being unlikely to be influenced by noise can be realized.

(Fourth Embodiment)

Unlike the third embodiment, the sliding members 43, 45 possess a heat conductivity and an insulating property in the fourth embodiment. Here, insulating property means that volume resistivity is 10¹⁰ Ω·cm or larger. The sliding members 43, 45 are made of a resin or a ceramic.

Here, an electrically nonconductive hard material is used as a filler for making the sliding members 43, 45 insulating. This electrically nonconductive hard material is preferably a ceramic such as an alumina or a mineral such as a ruby or a diamond. A mixing ratio of this filler is preferably between 20% (inclusive) and 80% (inclusive) by mass to a base material. If the content of the filler lies within this range, the moldability of the sliding members 43, 45 can be maintained while maintaining the heat-radiating property of the optical base 19.

By taking this construction, the optical base 19, the feed screw 36, the guide shaft 37 and the mechanism base 42 can be electrically shut off from each other. Accordingly, even if the sliding members 43, 45 are used in the optical head 50 in which there is a potential difference between the optical base 19 and the feed screw 36, the guide shaft 37 or the mechanism base 42, the optical head 50 and the optical disk driving device 55 having a good heat-radiating property and stable recording/reproducing performances can be realized.

This application is based on Japanese Patent Application Serial No. 2003-169063, filed In the Japan Patent Office on Jun. 13, 2003, the contents of which are hereby incorporated be reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical head, comprising:
a light source,
an objective lens for gathering a beam emitted from said light source on an optical information recording medium,
an objective lens actuator for driving said objective lens along a focusing direction and a tracking direction of the optical information recording medium,
a metal-made optical base for holding said light source and said objective lens actuator, and
a metal-made guiding member for guiding said optical base along the radial direction of the optical information recording medium,
wherein said optical base and said guiding member are held in contact via a heat conductive sliding member.

2. An optical head according to claim 1, wherein said optical base is made of any one of a press-worked product, forged product and a cast product of a metal.

3. An optical head according to claim 1, wherein said sliding member is made of either a resin or a ceramic.

4. An optical head according to claim 1, wherein said optical base is a press-worked product of a metal and includes a plate-shaped supporting portion for supporting said guiding member, and said supporting portion is formed to have a thickness between 0.2 mm and 1.2 mm inclusive.

5. An optical head according to claim 1, wherein:
said guiding member is formed to a shaft member extending along the radial direction of the optical information recording medium,
said optical base includes a supporting portion for supporting said guiding member,
said supporting portion is formed with one of a through hole and a groove, and
said sliding member is formed to have either an annular shape or a C-shape and mounted in said through hole or said groove of said supporting portion, and has said guiding member inserted thereinto.

6. An optical head according to claim 1, wherein the heat conductivity of said sliding member is between 5 W/m·k and 30 W/m·k inclusive.

7. An optical head according to claim 6, wherein the heat conductivity of said sliding member is between 10 W/m·k and 40 W/m·k inclusive.

8. An optical head according to claim 1, wherein said sliding member is made of a resin and electrically conductive.

9. An optical head according to claim 8, wherein said sliding member is made of such a resin in which 20% to 80% inclusive by mass of either one of a metal and a carbon is contained in a resin material at a base material.

10. An optical head according to claim 9, wherein said metal is any one of a copper-containing metal, an iron-containing metal and an aluminum-containing metal.

11. An optical head according to claim 1, wherein said sliding member is made of a resin and electrically insulating.

12. An optical head according to claim 11, wherein said sliding member is made of such a resin in which 20% to 80% inclusive by mass of an electrically nonconductive hard material is contained in a resin material as a base material.

13. An optical head according to claim 12, wherein said electrically nonconductive material is any one of a ceramic, a ruby and a diamond.

14. An optical head according to claim 1, wherein said optical base and said sliding member are integrally formed by molding.

15. An optical information recording medium driving device, comprising
a light source,
an objective lens for gathering a beam emitted from said light source on an optical information recording medium,
an objective lens actuator for driving said objective lens along a focusing direction and a tracking direction of the optical information recording medium,
a metal-made optical base for holding said light source and said objective lens actuator,
a metal-made guiding member for guiding said optical base along the radial direction of the optical information recording medium,
a tracking controller for calculating a tracking error signal and controlling the position of said objective lens in accordance with the calculated tracking error signal to cause a gathered light spot to follow a specified information track on the optical information recording medium, and
a focusing controller for calculating a focusing error signal and controlling the position of said objective lens in accordance with the calculated focusing error signal to cause the gathered light spot on the optical information recording medium,
wherein said optical base and said guiding member are held in contact via a heat conductive sliding member.
